(19) United States
(12) Patent Application Publication
(10) Pub. No.: US 2008/0271256 A1
(43) Pub. Date: Nov. 6, 2008

(54) ACCESS HANDLE FOR MULTITOOL M&A

(76) Inventor: Spencer Frazer, Lynnwood, WA (US)

Correspondence Address: HUGHES LAW FIRM, PLLC, PACIFIC MERIDIAN PLAZA, SUITE 302, 4164 MERIDIAN STREET, BELLINGHAM, WA, 98226-5583, US

(21) Appl. No.: 11/743,032

(22) Filed: May 1, 2007

(51) Int. Cl. B25B 7/22

(52) U.S. Cl. 7/128; 7/125; 7/168

(57) ABSTRACT

A multitool having an orientation of the handles in such a manner to allow access of various tools while the multitool is in a closed orientation and the plier region is contained within a central channel region of the first and second handle members.

### BACKGROUND OF THE INVENTION

In general, multi-tools have been utilized where such tools provide a variety of functionality. Most multitools have properties where the first and second handle members are arranged in a manner so as to operatively function as a plier portion. Many multitools have a principal method of operating where when the tool is an open orientation, by squeezing first and second handles together, the corresponding plier members of each tool are further squeezed together.

The handle regions in the multitool generally have an open region that allows for various tool members contained within each of the handles (generally in more than just one handle) to be accessed and withdrawn from the handle. For example, many types of tools such as scissors, knives, or the like are generally extractable and can be utilized by the operator for various purposes, making the tool very versatile.

However, many of the prior art tools that allow a proper configuration for accessing the various tools contained within the handle, as described herein, there are various embodiments for accessing various tools contained within the first and second handles of the multitool when the multitool is in a closed orientation.

### SUMMARY OF THE DISCLOSURE

A multitool comprising a jaw region having first and second jaw members, the jaw members comprising first and second handle members operatively attached to the jaw region, the first and second handle members having a closed orientation where the jaw region is positioned between the first and second handle members in an open orientation, each handle member having a central channel region. Each channel region comprises a plurality of tools pivotally attached to the first and second handle members and positioned within the central channel region when in a stored orientation and the tools further having an extended orientation.

The multitool further comprises the first and second handle members, each having a tool access portion configured to allow access to tools contained within the handle member. The first handle member is arranged where a transverse width of the first handle member is sufficiently greater than a transverse width of the second handle member that a transversely outward positioned tool in the first handle member is operatively arranged to reposition past the second handle member from a stored orientation to an extended orientation while the first and second handle members are in a closed orientation.

In another embodiment, the second handle member of the multitool has the tool access portion faced laterally outwardly while in the closed orientation. Additionally, the first handle member may have the tool access portion positioned laterally inwardly.

In yet another embodiment of the multitool, a second transverse outward portion of the first handle member is orientated sufficiently outward from a center longitudinal axis to allow access of a second transversely outward positioned tool to pass the second handle member while the multitool is in the closed orientation. The locking mechanism of the second handle member can be positioned laterally inwardly of the second handle member.

### BRIEF DESCRIPTION OF THE DRAWINGS

FIG. 1 shows a front view of the tool along a transverse axis in an open orientation where a plurality of tools are shown extended from the central channel region of the first and second handle members;

FIG. 2 shows a side view of the multitool in a closed orientation where the plier region is contained within the first and second handle members;

FIG. 3 shows an alternative embodiment where the second handle member has a tool access region that is exposed laterally outwardly with respect to the center longitudinal axis of the tool;

FIGS. 4A-4C are taken along line 4-4 of FIG. 2 where FIG. 4A shows one configuration where the transverse width of the first and second handle members is substantially the same;

FIG. 4B shows a configuration where the first and second handle members have a tool access region both facing laterally inwardly but the transverse with of the second handle member allows a first tool positioned in the first transverse region of the first handle member to pass thereby when in a closed orientation;

FIG. 4C shows an orientation where the first and second handle members have the open access region face laterally inwardly but tools in the first handle member at first and second transverse regions are configured to pass by the second handle member;

FIGS. 5A-5C show an orientation taken at line 5-5 of FIG. 3 where, in Fig. A, the second handle member has an open access region faced in the laterally outward region when in a closed orientation;

5B shows an orientation where the second handle member is facing laterally outwardly and has a transverse width sufficiently narrow to allow a tool in the first transverse region of the first handle member to pass thereby when in a closed orientation;

FIG. 5C shows a configuration where the second handle member has the open access region facing laterally outwardly and further has a sufficiently narrow transverse width and orientation in the transverse direction to allow first and second tool members located in the first and second transverse regions of the first handle member to pass thereby;

FIG. 6 shows another embodiment of a multitool.

### DETAILED DESCRIPTION OF THE PREFERRED EMBODIMENTS

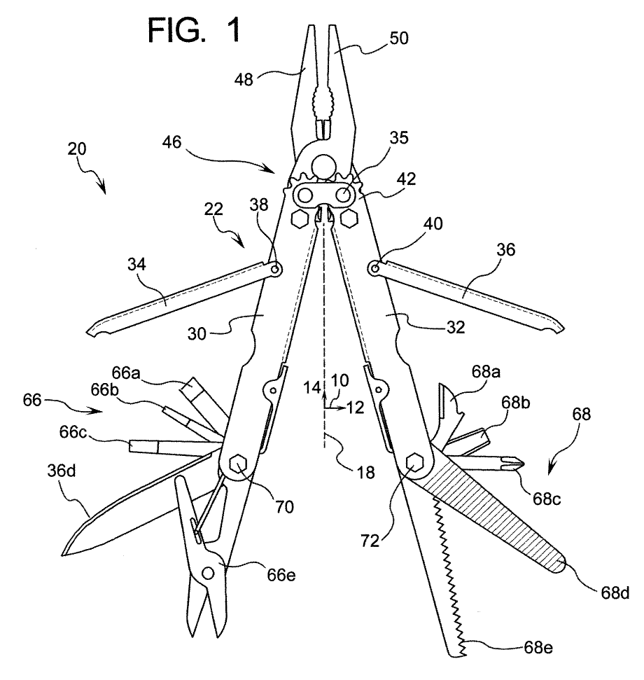

The multitool 20 as shown in FIG. 1 is shown in open illustration in an open orientation illustrating the various tool members 36 and 38. The individual tool members are noted by the alpha character following the general numeric number.

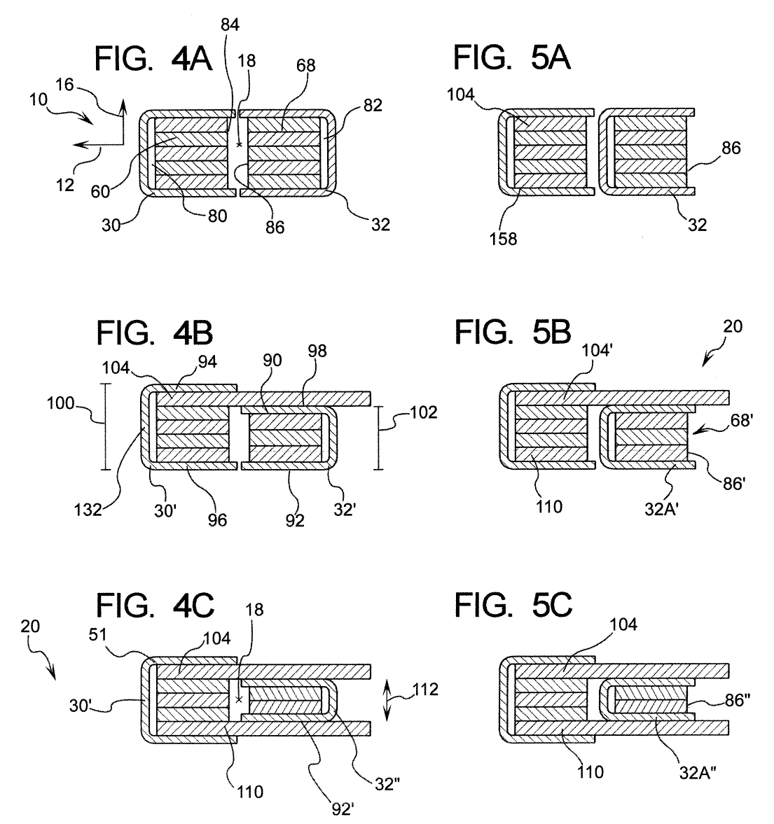

Before going into further discussion of the multitool 20, there will first be a description of a reference axis system to aid in the description of the embodiments. As shown in FIG. 1, the axis system 10 comprises a transverse axis 12 and a longitudinal axis 14. Further, the axis which is orthogonal to the axes 12 and 14 is the lateral axis 16 as shown in FIG. 4A at 16. Further, as shown in FIG. 4, and for example in FIG. 4C, there is a center longitudinal axis 18.

There will now be a description of the general regions and components of the multitool 20. In general, the multitool 20 as shown in FIG. 1 comprises a handle region 22 and a jaw region 24, which in one form is a plier region. The handle region 22 is comprised of first and second handle members 30 and 32. Each of the handle members has a tool cover 34 and 36 pivotally attached at the pivot attachment locations 38 and 40 as shown in FIG. 1. The handle region has a central region 42 where the handles are pivotally attached to the plier region 24. In one form, the handle region 22 is attached by way of a gear lock system at the more central region all of the multitool toward the jar region 47 a which are described in U.S. Pat. Nos. 6,003,180, 6,070,504 and 6,282,997 which are fully incorporated by reference.

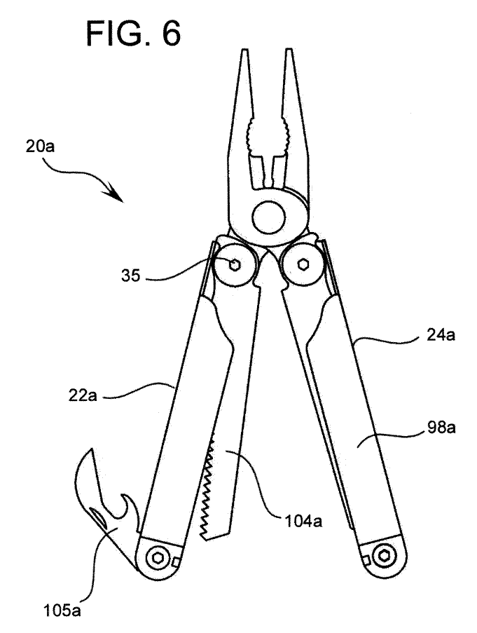

The plier region 24 is comprised of first and second jaw members 48 and 50 which are operatively attached to the handle members 30 and 32 to contract in a transverse inward direction with respect to the transverse inward relocation of the handle members 30 and 32. In one form, the members 30 and 32 as well as the members 50 and 48 are directly attached to one another at a tail region 53 by the pivot member 51 to have a plier-like action. The pivot member can be integral with one of the jaw members or a separate component. In one form, the first and second jaw members 40 and 50 are plier members such as needle nose pliers. However, in other forms, the jaw members could be (for example) shearing mechanisms to shear brush or the like, or other types of tools whereby each of the members forcefully engage one-another and produce some form of functional or desirable effect. As described above, these members can be gearingly attached with a compound gear-like mechanism. Alternatively a multitool 20a such as that as shown in FIG. 6 can be utilized with the spacing of the handles and orientation of the tool access regions which will be described further herein.

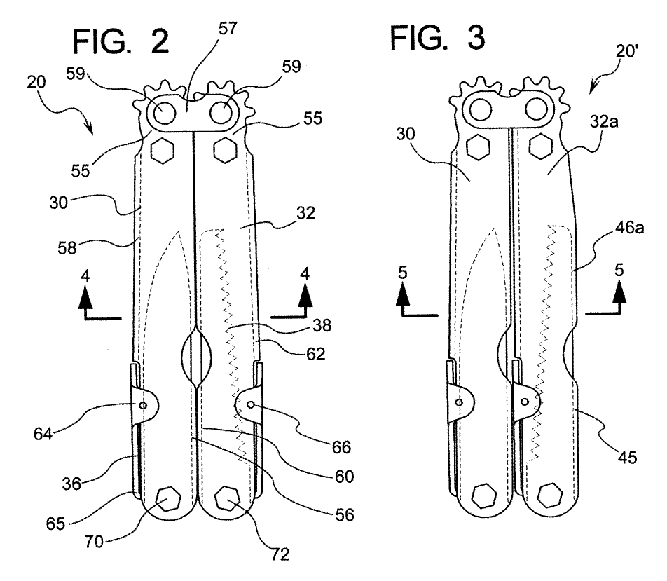

Now referring to FIG. 2, the multitool 20 is shown in a closed orientation. FIGS. 2 and 3 show the multitool 20 in closed orientations. The handle portion 30 has an open transverse region 56 and a closed transverse region 58. Further, in a like manner, the handle member 32 has an open transverse region 60 and a closed transverse region 62. In one form, positioned at the closed transverse region of each side are locking mechanisms 64 and 66. In one form, this locking mechanism is a spring activated lock adapted to engage grooves within the individual tools 66 and 68.

The tools 36 and 38 are pivotally attached at the pivot attachment locations 70 and 72. In other forms, the tools are attached at the head region 42 of the handle.

As shown in FIG. 1, the plurality of tools 66 and 68 can be positioned in an extended orientation similar to the tool members 66e and 68e, or in a stored orientation where the tools are positioned within the chamber region 80 of the handle members 30 and 32. As shown in FIG. 1, the plurality of tool members 66a-66e are laterally spaced from one other, and referring to FIG. 4B, one of the tool members is positioned in a laterally outward region 94 of the first handle member 30′. This particular tool member is referred to as a first lateral outward tool member, and the orientation of this tool member with the second handle member will be further described herein.

As shown in FIGS. 2 and 3, there are two variations of the multitool 20. In one form, the handle members each have a first longitudinal region 55 where the members are connected to the pivot connection member 57 at the pivot connection axis 59. As noted above, this linkage system is described thoroughly in the Applicant's previous patents, U.S. Pat. Nos. 6,003,180, 6,070,504 and 6,282,997. Referring back to FIG. 1, it should be noted that the locking mechanism 64, which in one form is a lever-like lock having the extension portion 65 to engage the grooves within the tool member is one form of a lock. Of course, other forms could be utilized as well, particularly in the orientation as shown in FIG. 3 as well as the cross-sectional views in FIGS. 5A-5C. It should be further noted that the tool covers 34 and 36 are optional in one form, and would not be employed in some of the embodiments.

Referring now to FIG. 4A, there is shown the first handle member 30 taken along line 4-4 of FIG. 2. As shown in this cross-sectional view, it can be seen how the handle members have a central channel 80 and 82. The tool members 66 and 68 are positioned within the respective central channels 80 and 82. Further, the handle members 30 and 32 define tool access regions 84 and 86 which provide open access for accessing the tools contained in the central channels 80 and 82. As shown in FIG. 4B, it can be seen how the second handle member 32′ has a first laterally outward region 90 and a second laterally outward region 92. Further, the first tool member 30′ also has a first laterally outward region 94 and a second laterally outward region 96. Located at the first laterally outward region 90 of the second tool member 32′ is a first laterally outward surface 98. The first handle member 32′ has a lateral width 100, which is greater than the lateral width 102 of the second tool member 32′. Therefore, it can be appreciated that the first laterally outward tool member indicated at 104 can pass by the second tool member 32′ when the first and second handles are in a closed orientation, such as that shown in FIG. 4B. Now referring to FIG. 5B, it can be appreciated that the second tool member 32A′ has the tool access region 86′ positioned in the transverse outward direction. Therefore, not only can the tool is' be accessed when the multitool 20 is a closed orientation, but further, the tools 68′ can further be accessed when the handle members are in a closed orientation.

It should be noted that FIG. 5A shows an embodiment where the tool access region 86 is positioned in the transverse outward direction as well. In other forms, the handle members can reposition in the lateral direction about, for example, a shaft support such as that shown as 35 in FIG. 1. Therefore, in one form, the second handle member 32 could reposition slightly in the lateral direction to give enough clearance to provide access for the first laterally outward tool member 104. Of course, this type of lateral reorientation could be utilized, for example, in FIG. 5B where the second handle member 32a′ would reposition in the lateral direction to allow access to the second laterally outward tool member 110.

Now referring to FIG. 4C, there is shown not only the first laterally outward tool member 104 but further a second laterally outward tool member 110 positioned at the opposing lateral region of the first handle member 30′. If this form, the second handle member 32″ has a lateral width indicated at 112 which is much less than the lateral width of the first handle member. Therefore, as shown in this figure, the second laterally outward tool member 110 can pass by the second transverse region 92′ so either the tool members 104 or 110 can be accessed when the handle members are in a closed orientation. FIG. 5C shows a similar orientation, with the exception that the open access region 86″ of the handle member 32A″ is positioned in the transverse outward direction.

Referring now to FIG. 6, there is shown a multitool 20 where, for example, the tool member 104a is pivotally attached at a pivot attachment location 35 which is positioned near the base region of the handle member/region 22a. In this form, the width of, for example, of the handle member 22a in the transverse direction can be greater than the transverse width of the second handle member 24a so the tool member can pass by the first laterally outward surface 98a. In a like manner, the tool member 105a can pass beyond the surface 98a when the first and second handle members 22a and 24a are in a closed orientation.

While the present invention is illustrated by description of several embodiments and while the illustrative embodiments are described in detail, it is not the intention of the applicants to restrict or in any way limit the scope of the appended claims to such detail. Additional advantages and modifications within the scope of the appended claims will readily appear to those sufficed in the art. The invention in its broader aspects is therefore not limited to the specific details, representative apparatus and methods, and illustrative examples shown and described. Accordingly, departures may be made from such details without departing from the spirit or scope of applicants' general concept.

Therefore I claim:

1. A multitool comprising:
a. a pair of opposed first and second jaw members, a first pivot member swingably connecting the first and second jaw members for movement relative to each other, each of the jaw members having a working end portion extending from the first pivot member in a first direction and a butt portion extending from the first pivot in a second, generally opposite direction,
b. first and second handle members operatively attached to the first and second jaw members, the first and second handle members having a closed orientation where the jaw members are positioned between the first and second handle members and an open orientation, each handle member having a central channel region and each handle member of comprising a plurality of tools pivotally attached to the first and second handle members and positioned within the central channel region when in a stored orientation and the tools further having an extended orientation,
c. the first and second handle members each having a tool access portion configured to allow access to tools contained within the handle member,
d. the first handle member being arranged where a transverse width of the first handle member is sufficiently greater than a transverse width of the second handle member that a transversely outward positioned tool in the first handle member is operatively arranged to reposition past the second handle member from a stored orientation to an extended orientation while the first and second handle members are in a closed orientation.

2. The multitool as described in claim 1 where the second handle member has the tool access portion faced laterally outwardly while in the closed orientation.

3. The multitool as recited in claim 2 where the first handle member has the tool access portion positioned laterally inwardly.

4. The multitool as recited in claim 1 where a second transverse outward portion of the first handle member is orientated sufficiently outward from a center longitudinal axis to allow access of a second transversely outward positioned tool to pass the second handle member while the multitool is in the closed orientation.

5. The multitool as recited in claim 1 where a locking mechanism of the second handle member is positioned laterally inwardly of the second handle member.

6. A multitool comprising a handle region having first and second handle members, each handle member having a transverse width whereby the first handle member has a transverse width greater than the second handle member where a tool of the first handle member can pass by the second handle member from a closed orientation to an open orientation.

7. The multitool as recited in claim 6 where the first handle member further comprises a first transverse outward portion and a second transverse outward portion, whereby the first tool and the second tool positioned in the first and second transverse portions respectively can pass by the second panel member when the multitool is in a closed orientation.

8. The multitool as recited in claim 6 where the second handle member comprises a channel portion having an open area, where the open area is faced laterally outwardly from a center portion of the handle region when in a closed orientation.

9. A multitool comprising:
a. first and second handle members, the first and second handle members being pivotally connected to a plier region comprising first and second plier members,
b. the first and second handle members having an open orientation where the first and second plier members are extended, the first and second handle members further having a closed orientation,
c. the first and second handle members each having a central channel having first and second transverse sides where the second lateral side of each member defines a tool access region where the tool access region of the second handle member is facing laterally outwardly and the tool access region of the first handle member is facing laterally inwardly when the multitool is in a closed configuration and the first and second plier members are stored within the central channel regions of the first and second handle members.

10. The multitool as recited in claim 9 where the second handle member has a lateral width that is a lesser value than the transverse width of the first handle member whereby a tool positioned in the first transverse region of the first handle member can be withdrawn from the central chamber region and pass by the first transverse region of the second handle member.

11. The multitool as recited in claim 10 where a tool positioned in a second transverse region of the first handle member can pass by a second transverse region of the second handle so the tool can be withdrawn from the central chamber region.

12. A method of extracting a tool from a multitool having longitudinal lateral and lateral axes where the longitudinal axis extends substantially along first and second handle members, and the lateral axis extend substantially along a pivot attachment portion of a plurality of tools positioned within the first and second handle members, the first and second handle members having a central channel region that is operatively configured to house a plurality of tools therein, the central channel region defining a tool access region which provides a substantially open area to withdraw tools therefrom, the tool access region of the second handle member facing laterally outwardly when the first and second handles are in a closed orientation and the tool access region of the first channel member being faced laterally inwardly when the first and second handle members are in a closed orientation.

13. A multitool having lateral and transverse axes comprising:
a. a jaw region having first and second jaw members, the first and second jaw members being pivotally attached to each other,
b. a handle portion comprising first and second handle members, the first and second handle members each having a chamber region and first and second outer lateral regions, the first and second handle members further having a tool access region providing access to the channel region,
c. a plurality of tool members pivotally attached to the first and second handle members about a lateral axis and being reposition from a stored orientation being positioned within the channel region of either of the first or second handle members and further having an extended orientation where the tool members are operatively configured to rotate about the lateral axis in the transverse direction from the stored orientation to the extended orientation, at least one of the tool members being a laterally outward tool member positioned on the first handle member,
d. the handle portion and the jaw region being configured to have an open orientation and a closed orientation where in the closed orientation the first and second jaw members are positioned in a portion of the channel regions of the first and second handle members,
e. whereas the laterally outward tool member is positioned sufficiently laterally outward in the first outer lateral region of the first handle number with respect to the first laterally outward region of the second handle member whereby the first laterally outward tool member of the first handle member can extend from the stored orientation to the extended orientation passing by the first laterally outward region of the second handle member where the handle members are a closed orientation.

14. The multitool as recited in claim 13 where the first lateral outward region of the second handle member comprises a first laterally outward surface and the laterally outward tool member of the first handle member passes laterally outward from the surface from the stored orientation to the extended orientation.

15. The multitool as recited in claim 13 where the tool access region of the second handle member faces in a transverse inward direction when the handle members are in a closed orientation.

16. The multitool as recited in claim 13 where the second handle member is orientated so the tool access region faces a transverse outward direction when the handle members are in a closed orientation.

17. The multitool as recited in claim 16 where the tool members of the second handle member are accessible when the handle members are in a closed orientation.

18. The multitool as recited in claim 13 where a second laterally outward positioned tool member is positioned at the second laterally outward region of the first handle member, and the second laterally outward positioned tool member is operatively configured to be repositioned from the stored orientation within the channel region of the first handle member to an extended orientation when the handle members are in a closed orientation whereby the second laterally outward region of the second tool member is positioned sufficiently laterally inwardly to abstract the second laterally outward positioned tool member to reposition between the stored orientation to the extended orientation.

19. The multitool as recited in claim 13 where the jaw region is a needle-nose plier assembly.

20. The multitool as recited in claim 13 where the laterally outwardly positioned tool member is a blade.

21. The multitool as recited in claim 13 where the first and second handle members each have a first longitudinal region and are pivotally connected to a pivot connection member about pivot connection axes, and the first and second handle members are further pivotally connected to the first and second jaw members at the pivot connection axes.

22. The multitool as recited in claim 21 where the first and second handle members are gearingly engaged to move with one-another in conjunction with respect to movement of the jaw region.

23. The multitool as recited in claim 13 where the first and second jaw members are shearing members.
